(19) United States
(12) Patent Application Publication
(10) Pub. No.: US 2024/0269915 A1
(43) Pub. Date: Aug. 15, 2024

(54) SYSTEMS AND METHODS FOR MAKING POLYMER DENTAL APPLIANCES

(71) Applicant: Carbon, Inc., Redwood City, CA (US)

(72) Inventors: Keshav Swarup, San Mateo, CA (US); Gregory Robert Robbins, Redwood City, CA (US); Bob E. Feller, San Mateo, CA (US); Alexander D. Denmark, Redwood City, CA (US); Owen Lu, San Mateo, CA (US)

(21) Appl. No.: 18/567,589

(22) PCT Filed: Jun. 2, 2022
(86) PCT No.: PCT/US2022/031907

§ 371 Date: Dec. 6, 2023

Related U.S. Application Data
(60) Provisional application No. 63/208,742, filed on Jun. 9, 2021.
(60) Provisional application No. 63/250,380, filed on Sep. 30, 2021.

(51) Int. Cl. B29C 51/30; A61C 7/08; B29C 33/38; B29C 64/124; B29C 64/194; B29C 64/245; B29L 31/00; B33Y 10/00; B33Y 30/00; B33Y 40/00; B33Y 80/00

(52) U.S. Cl. CPC B29C 51/30; A61C 7/08; B29C 33/3842; B29C 64/194; B33Y 40/00; B33Y 80/00; B29C 64/124; B29C 64/245; B29L 2031/753; B29L 2031/757; B33Y 10/00; B33Y 30/00

(57) ABSTRACT

A method of making a plurality of polymer dental appliances, including the steps of: (a) additively manufacturing a plurality of hollow molds from a polymerizable resin, each mold having an external surface portion configured in the shape of a dental arch and a bottom portion having a hollow cavity therein, and with the additively manufacturing step carried out with the plurality of hollow molds formed on a build platform; (b) centrifugally separating residual resin from both the external surface portion and the bottom portion (including the hollow cavity) of each mold; (c) further curing, concurrently or sequentially, the external surface portion and the bottom portion of each mold with ultraviolet light; then (d) thermoforming a thermoplastic polymer sheet on each hollow mold external surface portion to produce the plurality of polymer dental appliances; and (e) separating the plurality of polymer dental appliances from the plurality of hollow molds.

### RELATED APPLICATIONS

This application claims priority from U.S. Provisional Application Nos. 63/208,742, filed Jun. 9, 2021, and 63/250,380, filed Sep. 30, 2021, the disclosures of which are hereby incorporated by reference in their entireties.

### FIELD

Disclosed are methods and systems for making polymer dental appliances such as dental aligners by thermoforming polymer sheets on additively manufactured molds. Methods of cleaning and further curing interior surfaces of hollow molds are also described.

### BACKGROUND

Polymer dental appliances such as clear aligners are made by additively manufacturing a mold in the shape of a patient's dental arch, and then thermoforming a sheet of thermoplastic material over that mold. See, e.g., U.S. Pat. No. 7,261,533. Prior to thermoforming, it is important that residual resin be cleaned from all surfaces of the molds-typically accomplished by washing the molds with ethanol (See, e.g., Van Esbroek, Sharma, Lam and Chin, Method and apparatus for forming an orthodontic aligner, U.S. Pat. No. 10,575,925; see also Graham, Laaker and Barth, Rapid Wash System for Additive Manufacturing, US Patent Application Pub. No. US 2019/0255774).

A problem with washing, however, is that it produces contaminated wash liquids which present further processing problems. A possible alternative is centrifugal cleaning, which has been generally described for additive manufactured objects (Murillo and Dachs, Resin extractor for additive manufacturing, US Patent App. Pub. No. 2021/0086450 (Mar. 25, 2021); Hiatt et al., Method for removing and reclaiming unconsolidated material from substrates following fabrication of objects thereon by programmed material consolidation techniques, US Patent App. Pub. No. 2004/0159340 (Aug. 19, 2004); and Converse et al., Systems and methods for resin recovery in additive manufacturing, PCT Patent App. Pub. No. WO 2020/146000 (Jul. 16, 2020)).

Another problem with additively manufactured thermoforming molds is that the molds themselves are typically discarded. This represents considerable waste of material, and hence it is also desirable to minimize the amount of material from which the mold is made. This might be achievable by making hollow molds. However, centrifugal cleaning hollow molds appears difficult, as the hollow cavities themselves, in addition to the outer surfaces of the mold, must also be cleaned—and centrifugation procedures that are optimized for cleaning the surface of a mold may not be effective in cleaning an interior cavity within the mold. Accordingly, there is a need for new approaches to cleaning hollow molds for use in making dental appliances.

### SUMMARY

A method of making a plurality of polymer dental appliances is described herein, which method includes the steps of:
(a) additively manufacturing a plurality of hollow molds from a polymerizable resin, each mold having an external surface portion configured in the shape of a dental arch and a bottom portion having a hollow cavity therein, and with the additively manufacturing step carried out with the plurality of hollow molds formed on a build platform; then
(b) centrifugally separating residual resin from both the external surface portion and the bottom portion (including the hollow cavity) of each of the plurality of molds; then
(c) further curing, concurrently or sequentially, the external surface portion and the bottom portion of each of the plurality of molds with ultraviolet light; then
(d) thermoforming a thermoplastic polymer sheet on each hollow mold external surface portion to produce the plurality of polymer dental appliances; and then
(e) separating each of the plurality of polymer dental appliances from each corresponding hollow mold.

In some embodiments, the centrifugally separating step is carried out with the plurality of hollow molds retained on the build platform.

In some embodiments, each of the plurality of hollow molds is oriented vertically on the build platform.

In some embodiments, each of the plurality of hollow molds is oriented horizontally on the build platform, with the bottom portion on (e.g., directly on) said build platform.

In some embodiments, each of the plurality of hollow molds has a plurality of residual resin drain openings formed therein, each drain opening communicating between or extending between said hollow cavity and the external surface portion.

In some embodiments, each of the plurality of hollow molds further includes a grid (e.g., a grid formed from struts, optionally with at least some of the struts interconnected at nodes), the grid formed in an supporting the hollow cavity.

In some embodiments, the grid is on the build platform.

In some embodiments, at least 30 percent of the total volume of the hollow mold is occupied by the hollow cavity.

In some embodiments, the build platform including a release sheet adhered thereto, with the plurality of hollow molds adhered to the release sheet. This provides for additional advantages and features discussed further below.

In some embodiments, the further curing step (c) is carried out by:
(c₁) separating the release sheet from the build platform with the hollow molds retained on the release sheet; and then
(c₂) further curing said bottom portions (including the hollow cavities) by illuminating the bottom portions with ultraviolet light through the release sheet; and then
(c₃) separating each hollow mold from said release sheet.

In some embodiments, the further curing of the plurality of hollow molds is carried out concurrently.

In some embodiments, the further curing of the external surface portion and the bottom portion of each said plurality of molds is carried out concurrently.

In some embodiments, the thermoplastic polymer sheet includes a clear polymer sheet.

In some embodiments, the dental appliances include orthodontic aligners, orthodontic retainers, orthodontic splints, dental night guards, dental bleaching (or whitening) trays, or a combination thereof.

In some embodiments, the plurality of polymer dental appliances include at least one progressive set of dental appliances (e.g., a progressive set of dental aligners) for a specific patient.

In some embodiments, the centrifugally separating step is carried out in an enclosed chamber containing a volatile organic solvent vapor (i.e., the solvent in gas form), without contacting liquid organic solvent to the hollow molds, with the vapor present in an amount sufficient to reduce the viscosity of the residual resin. This too provides for additional advantages and features discussed further below.

In some embodiments: at least one or each arch or mold has a first and second opposing back portions, a front portion, and a pair of opposite lateral portions therebetween; the cavity extends from the first back portion to the second back portion through the front portion and the opposite lateral portions; at least one of or each of the lateral portions and said front portion includes at least one drain opening (with the drain openings preferably on the buccal surface of the arch); and the centrifugally separating step (b) includes flowing said residual resin through the cavity and the drain openings.

In some embodiments, at least one of the front portion, and the pair of opposite lateral portions includes two drain openings (e.g., each lateral portion includes one drain opening, and the front portion includes two spaced apart drain openings; each lateral portion includes two spaced apart drain openings and the front portion includes one drain opening; etc, with the drain openings preferably on the buccal surface of said arch.) In some embodiments, the drain openings have an average diameter of from 0.6 to 1.3 mm (e.g., 1 mm) and are spaced apart from one another an average of from 2 to 8 mm (e.g., 4 mm).

In some embodiments, each back portion includes either a drain opening or a vent opening.

In some embodiments, the height of each drain opening is greater than the height of the cavity in the region of the cavity adjacent each drain opening.

In some embodiments, the height of the cavity or drain opening is: (i) substantially the same throughout the arch, or (ii) contoured through the arch in a configuration to facilitate the flow of residual resin out of the hollow cavity during centrifugation on a carrier platform when mounted in any of a plurality (e.g., at least three, four, five or more) of positions on the carrier platform.

Hollow molds useful for carrying out these methods, and apparatus useful for carrying out steps of these methods, are also described and discussed further below.

A hollow mold produced by additive manufacturing from a polymerizable resin is described herein, with the mold having an external surface portion configured in the shape of a dental arch and a bottom portion having a hollow cavity therein, the mold having a plurality of residual resin drain openings formed therein, each drain opening communicating between or extending between the hollow cavity and the external surface portion.

In some embodiments, the external surface portion has an upper portion and a side portion, and with the bottom portion having a base surface portion, with the residual resin drain openings formed in said side portion.

In some embodiments, the base surface portion is planar.

In some embodiments, the mold further includes a grid formed from struts (optionally with at least some of the struts interconnected at nodes), the grid formed in and supporting the hollow cavity.

In some embodiments, the struts of the grid are coplanar with the base surface portion.

In some embodiments, the struts have top, bottom, and side surface portions, the bottom surface portions are coplanar with the base surface portion, and: the top surface portions are configured (e.g., peaked or domed) to promote drainage of residual resin); and/or the struts include resin drain openings (e.g., channels extending through the side surface portions) formed therein.

In some embodiments, at least 30 percent of the total volume of the hollow mold is occupied by the hollow cavity.

In some embodiments, the drain openings are either closed from or open to the base surface portion.

In some embodiments: the arch has a first and second opposing back portions, a front portion, and a pair of opposite lateral portions therebetween; the cavity extends from the first back portion to the second back portion through the front portion and the opposite lateral portions; and each of the lateral portions and the front portion includes at least one drain opening (with the drain openings preferably on the buccal surface of the arch).

In some embodiments, at least one of the front portion, and the pair of opposite lateral portions includes two drain openings (e.g., each lateral portion includes one drain opening, and the front portion includes two spaced apart drain openings; each lateral portion includes two spaced apart drain openings and the front portion includes one drain opening; etc, with the drain openings preferably on the buccal surface of the arch.)

In some embodiments, the drain openings have an average diameter of from 0.6 to 1.3 mm (e.g., 1 mm) and are spaced apart from one another an average distance of from 2 to 8 mm (e.g., 4 mm).

In some embodiments, each back portion includes either a drain opening or a vent opening.

In some embodiments, the height of each drain opening is greater than the height of the cavity in the region of the cavity adjacent each said drain opening.

In some embodiments, the height of the cavity or drain opening is: (i) substantially the same throughout the arch, or (ii) contoured through the arch in a configuration to facilitate the flow of residual resin out of the hollow cavity during centrifugation on a carrier platform when mounted in any of a plurality (e.g., at least three, four, five or more) of positions on the carrier platform.

A post-production curing chamber for additively manufactured objects is described herein, including: (a) a housing having an access door; (b) a light transmissive tray within the housing configured to receive a light-transmissive release sheet having a plurality of additively manufactured objects thereon; and (c) an ultraviolet light source connected to the housing and positioned to project light down toward the light transmissive tray; and (d) an ultraviolet light source connected to the housing and positioned to project light up through the light transmissive tray.

In some embodiments, the curing chamber further includes an inert gas source (e.g., a nitrogen source) connected to the housing.

In some embodiments, the light transmissive tray includes tempered glass, sapphire, or a combination thereof.

In some embodiments, the light transmissive tray is removably or slidably received on mounts or rails in the housing.

The foregoing and other objects and aspects of the present invention are explained in greater detail in the drawings herein and the specification set forth below. The disclosures of all United States patent references cited herein are to be incorporated herein by reference.

### BRIEF DESCRIPTION OF THE DRAWINGS

FIG. 1 is a perspective view of a first embodiment of a hollow mold as described herein;

FIG. 2 is a bottom plan view of the hollow mold of FIG. 1;

FIG. 3 is a top plan view of the hollow mold of FIG. 1;

FIG. 4 is a perspective view of a second embodiment of a hollow mold as described herein;

FIG. 5 is a perspective view of a third embodiment of a hollow mold as described herein;

FIG. 6 is a bottom plan view of the hollow mold of FIG. 5;

FIG. 7 is a perspective view of an additive manufacturing build platform having a plurality of hollow molds of FIGS. 1-3 adhered thereto in a vertical orientation;

FIG. 8 is a perspective view of an additive manufacturing build platform having a plurality of hollow molds of FIG. 4 adhered thereto in a horizontal orientation;

FIG. 9 is a schematic diagram of a single build platform of FIG. 8 mounted for centrifugal separation of residual resin from the hollow molds;

FIG. 10 is a schematic diagram of two (or more) build platforms of FIG. 8 mounted for centrifugal separation of residual resin from the hollow molds;

FIG. 11A is a schematic diagram of two (or more) build platforms of FIG. 8 mounted in an inward-facing configuration for centrifugal separation of residual resin from the hollow molds;

FIG. 11B is a schematic diagram similar to that of FIG. 11A, except that the top edge portions of the build platforms are now tilted inwards towards the rotor to direct flow of residual resin out from the bottom, or lower, edge portion of the build platform (as shown by the pair of dashed arrows).

FIG. 11C is a top plan view of the schematic illustration of FIG. 11A, mounting six build platforms, all in angled orientation to the axis of rotation and symmetric with one another;

FIGS. 12A and 12B are bottom plan views of a hollow model as described herein, showing how resin contained within the cavity can be centrifugally removed from the cavity regardless of the orientation of the mold on the build platform;

FIGS. 13A and 13B are sectional views of two different hollow molds as described herein, sectioned through a single drain opening, showing that the height of the drain opening above the build platform is at least as great as the height of the internal cavity (adjacent the drain opening) above the build platform.

FIG. 14 is a schematic diagram of a post-production curing chamber for additively manufactured hollow molds useful in the methods and systems described herein.

FIG. 15 is a flow chart illustrating one embodiment of a process as described herein.

FIG. 16A is a perspective view of a hollow mold as described herein, showing the grid, or “base grid” that supports the hollow cavity.

FIG. 16B is a bottom view of the mold of FIG. 16A.

FIG. 16C is a side sectional, perspective, view of the mold of FIGS. 16A-16B, taken along the dashed line g-g of FIG. 16B.

FIG. 16D is a side sectional, perspective, view of the mold of FIGS. 16A-16B, again taken along the dashed line g-g of FIG. 16B but viewed from a different perspective than FIG. 16C.

FIG. 17 is a side sectional schematic view of a mold as described in FIGS. 16A-16D, illustrating the volume of the hollow cavity.

### DETAILED DESCRIPTION OF ILLUSTRATIVE EMBODIMENTS

The present invention is now described more fully hereinafter with reference to the accompanying drawings, in which embodiments of the invention are shown. This invention may, however, be embodied in many different forms and should not be construed as limited to the embodiments set forth herein; rather these embodiments are provided so that this disclosure will be thorough and complete and will fully convey the scope of the invention to those skilled in the art.

As used herein, the term “and/or” includes any and all possible combinations of one or more of the associated listed items, as well as the lack of combinations when interpreted in the alternative (“or”).

### 1. Additive Manufacturing of Hollow Molds.

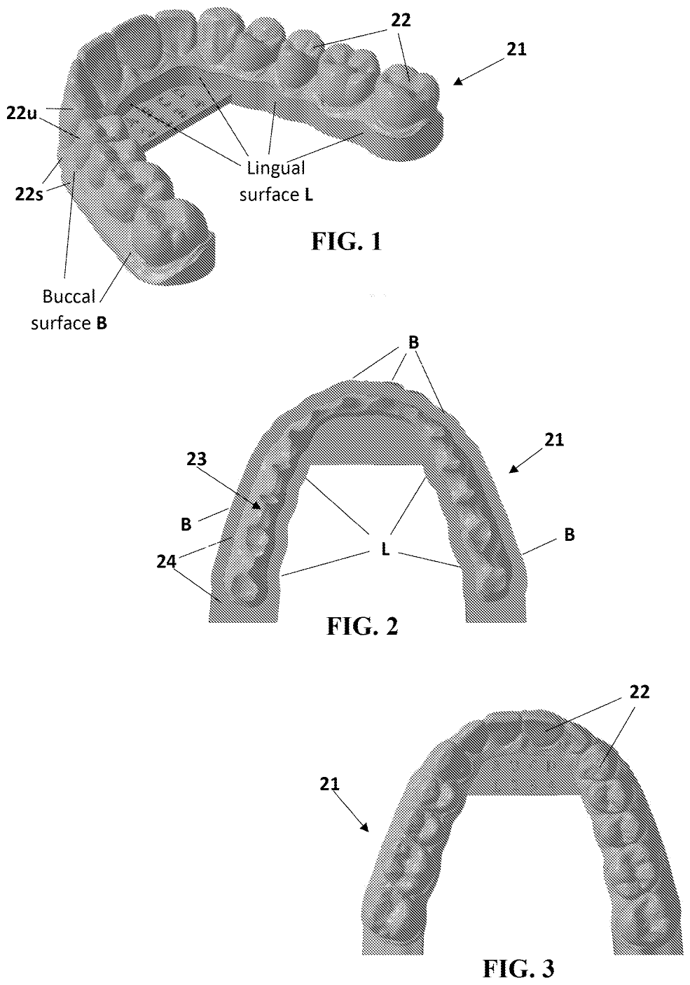

As shown by the non-limiting examples of FIGS. 1-6, hollow molds (21, 31, 31′) produced by additive manufacturing from a polymerizable resin typically have an external surface portion configured in the shape of a dental arch (22, 32, 32′) and a bottom portion having a hollow cavity (23, 33, 33′) therein. In some embodiments, the mold has a plurality of residual resin drain openings formed therein, each drain opening communicating between or extending between the hollow cavity and the external surface portion. The external surface portion typically has an upper portion (22u; 32u; 32u′) and a side portion (22s; 32s; 32s′), and with the bottom portion having a peripheral edge portion (24, 34′) (also referred to as a base surface portion), with the residual resin drain openings formed in the side portion. The base surface portion/peripheral edge portion can be planar, either due to the mold being adhered to the carrier platform when printed horizontally on a carrier platform during initial exposure, or even when printed vertically, so that the mold has a flat bottom to aid in placing into a thermoforming apparatus for the thermoforming step.

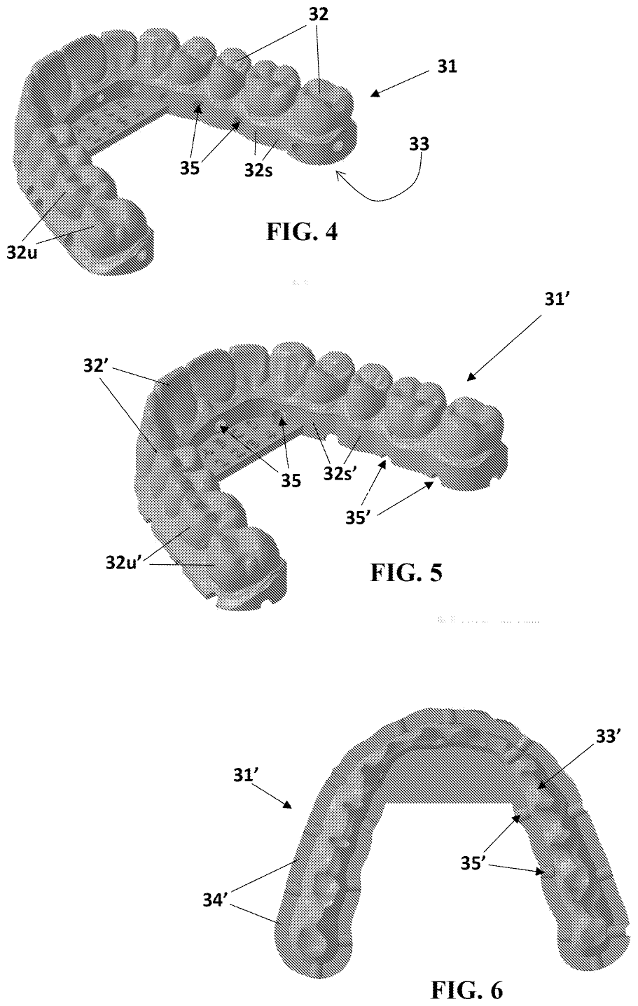

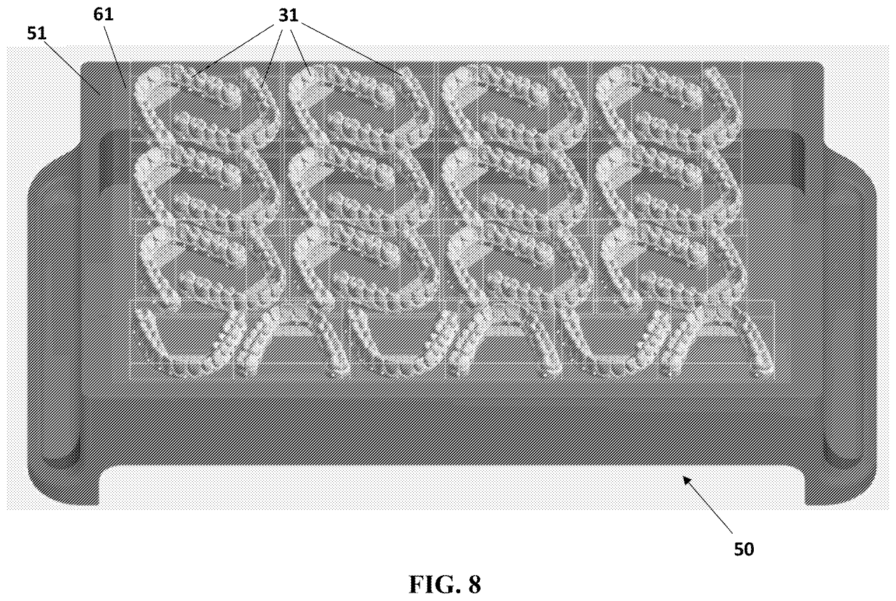

As noted above, in some embodiments (such as those intended for orientation of the molds horizontally on the build platform as shown in FIGS. 8-10) each of the plurality of molds has a plurality of residual resin drain openings formed therein, each drain opening communicating between or extending between the hollow cavity and the external surface portion. In some embodiments the drain openings are closed from (FIG. 4, 35; “windows”) the peripheral edge portion, while in other embodiments the draining openings are open to (FIGS. 5-6, 35′; “doors”) the peripheral edge portion. Of course, both styles can be included on a single mold, such as shown in FIGS. 5-6.

Suitable additive manufacturing methods and apparatus, including bottom-up and top-down additive versions thereof (generally known as stereolithography) are known and described in, for example, U.S. Pat. No. 5,236,637 to Hull, U.S. Pat. Nos. 5,391,072 and 5,529,473 to Lawton, U.S. Pat. No. 7,438,846 to John, U.S. Pat. No. 7,892,474 to Shkolnik, U.S. Pat. No. 8,110,135 to El-Siblani, U.S. Patent Application Publication No. 2013/0292862 to Joyce, and US Patent Application Publication No. 2013/0295212 to Chen et al. The disclosures of these patents and applications are incorporated by reference herein in their entirety.

In some embodiments, the additive manufacturing step is carried out by one of the family of methods sometimes referred to as continuous liquid interface production (CLIP). CLIP is known and described in, for example, U.S. Pat. Nos. 9,211,678; 9,205,601; 9,216,546; and others; in J. Tumbleston et al., Continuous liquid interface production of 3D Objects, Science 347, 1349-1352 (2015); and in R. Janusziewcz et al., Layerless fabrication with continuous liquid interface production, Proc. Natl. Acad. Sci. USA 113, 11703-11708 (Oct. 18, 2016). Other examples of methods and apparatus for carrying out particular embodiments of CLIP include, but are not limited to: Batchelder et al., US Patent Application Pub. No. US 2017/0129169 (May 11, 2017); Sun and Lichkus, US Patent Application Pub. No. US 2016/0288376 (Oct. 6, 2016); Willis et al., US Patent Application Pub. No. US 2015/0360419 (Dec. 17, 2015); Lin et al., US Patent Application Pub. No. US 2015/0331402 (Nov. 19, 2015); D. Castanon, S Patent Application Pub. No. US 2017/0129167 (May 11, 2017). B. Feller, US Pat App. Pub. No. US 2018/0243976 (published Aug. 30, 2018); M. Panzer and J. Tumbleston, US Pat App Pub. No. US 2018/0126630 (published May 10, 2018); K. Willis and B. Adzima, US Pat App Pub. No. US 2018/0290374 (Oct. 11, 2018) L. Robeson et al., PCT Patent Pub No. WO 2015/164234 (see also U.S. Pat. Nos. 10,259,171 and 10,434,706); and C. Mirkin et al., PCT Patent Pub. No. WO 2017/210298 (see also US Pat. App. US 2019/0160733).

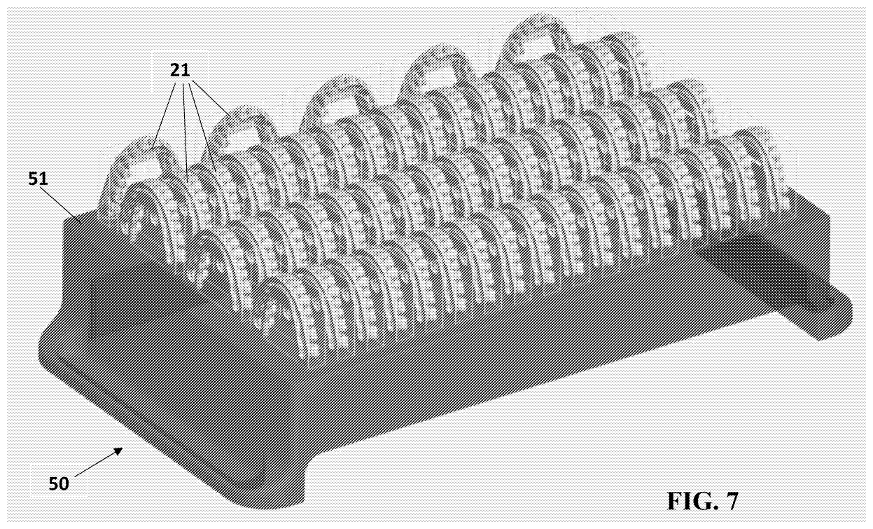

Any suitable build platform (50) can be used, including but not limited to that described in Dachs, Removable build platform for an additive manufacturing apparatus, PCT Patent Application Pub. No. WO2020/069167 (Sep. 26, 2019). In some embodiments, the build platform has a planar (build) surface (51) as shown in FIGS. 7-10.

In some embodiments such as illustrated in FIG. 7, each of the plurality of hollow molds is oriented vertically on the build platform. In other embodiments, such as illustrated in FIG. 8, each of the plurality of hollow molds is oriented horizontally on the build platform, with the bottom portion on (or directly on) the build platform.

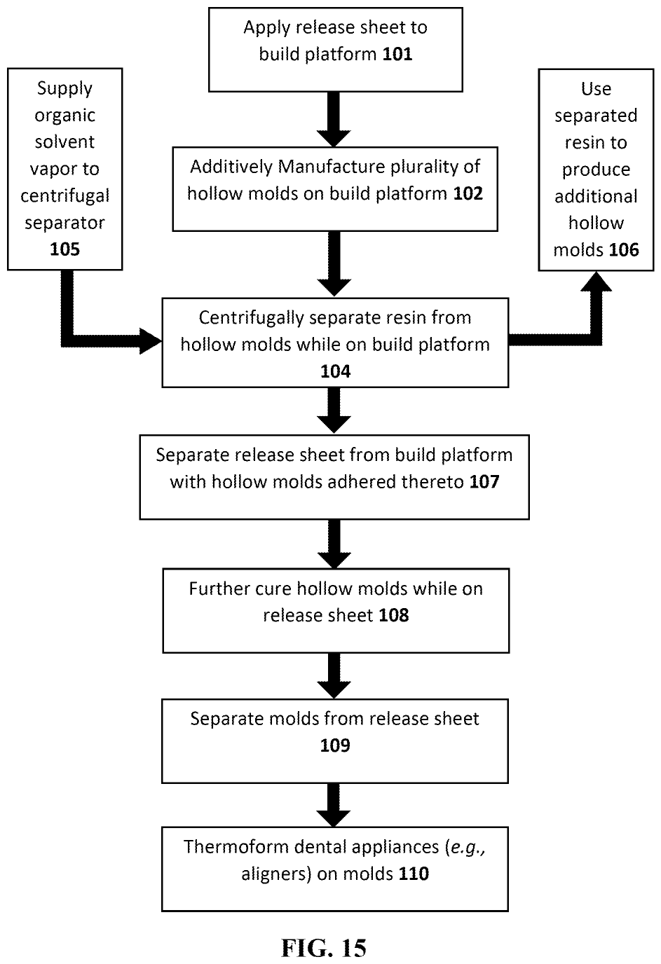

As shown in FIG. 8, an adhesive release sheet (61), preferably comprised of a light-transmissive polymer material, can be applied (FIG. 15, step 101) to the carrier platform prior to initiating additive manufacturing thereon so that the additively manufactured objects are adhered to the release sheet, and through the release sheet to the carrier platform, as described in X. Gu, PCT Patent Application Pub. No. WO 2018/118832 (published 28 Jun. 2018). Adhesion of the objects to the release sheet during and after removing the release sheet from the carrier platform can be promoted by strongly exposing the initial layer or slice of resin to light at the beginning of the additive manufacturing process, by employing adhesion-enhancing surface treatment such as texturing/microtexturing to the surface of the release sheet, etc., including combinations thereof.

### 2. Centrifugal Separation.

Centrifugal separation may be carried out by any suitable technique, including but not limited to those described in Murillo and Dachs, Resin extractor for additive manufacturing, US Patent App. Pub. No. 2021/0086450 (Mar. 25, 2021); Hiatt et al., Method for removing and reclaiming unconsolidated material from substrates following fabrication of objects thereon by programmed material consolidation techniques, US Patent App. Pub. No. 2004/0159340 (Aug. 19, 2004); and Converse et al., Systems and methods for resin recovery in additive manufacturing, PCT Patent App. Pub. No. WO 2020/146000 (Jul. 16, 2020).

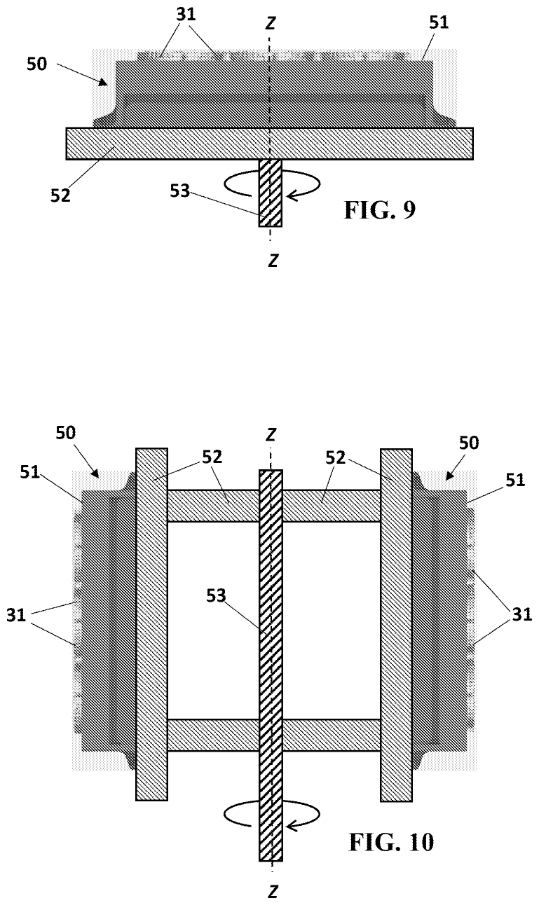

In one embodiment, the build platform (50) can be mounted on a support or turntable (52) with the planar build surface (51) horizontal and perpendicular to an axis of rotation (Z-Z) for spinning to centrifugally separate excess resin as shown in FIG. 9.

In another embodiment, the carrier platform (50) can be mounted on a support (52) with the planar build surface (51) oriented parallel to an axis of rotation (Z-Z) for spinning to centrifugally separate excess resin as shown in FIG. 10.

In still other embodiments, the build platform platform can be mounted on a support at an angle offset from (e.g., of from 10 to 80 degrees) from the axis of rotation. In one embodiment, the planar build surface is oriented perpendicularly to a radius of the rotor (53) and tangentially to the axis of rotation (Z-Z) of the rotor.

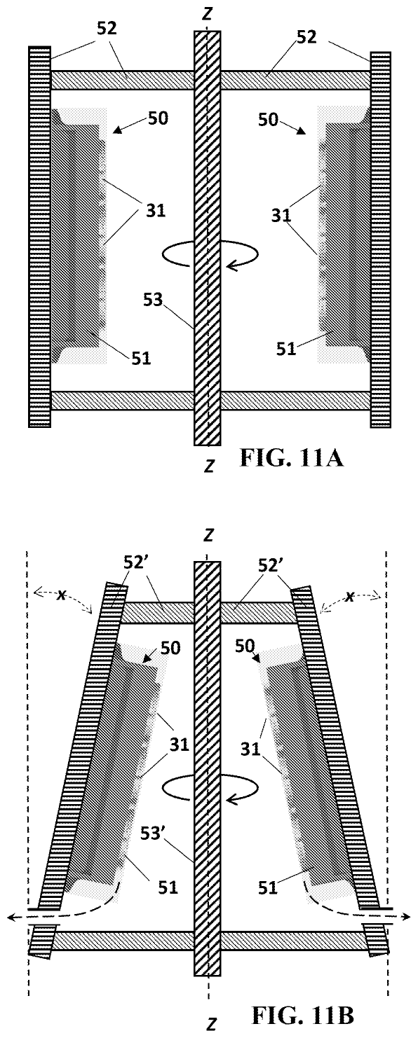

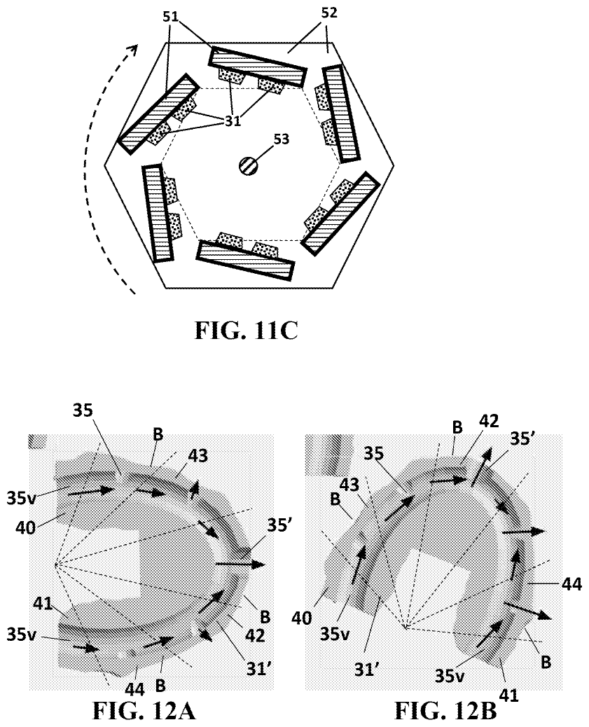

In still other embodiments, the build platforms can be mounted in an inward-facing (rotor-facing or axis of rotation facing) orientation, as shown in FIG. 11A, optionally with the upper edge (portion) of the build platform tilted inward toward the axis of rotation, as shown in FIG. 11B, and preferably with all build platforms oriented symmetrically with one another to facilitate balance, to direct the flow of residual resin outward along the bottom edge portion of the build platform, as shown by the dashed arrows in FIG. 11B.

In still another embodiment, the build platforms can be mounted in inward facing orientation, as shown by the top plan view in FIG. 11C, but with one side edge portion spaced further out from the axis of rotation (and all build platforms arranged symmetrically with one another to facilitate balance) to facilitate resin flow from that side edge portion.

Referring to FIGS. 12A and 12B, the arch (e.g., the external surface portion 32′ shown in FIG. 5) or the mold 31′ may have first and second opposing back portions (40, 41), a front portion (42), and a pair of opposite lateral portions (43, 44) therebetween. The cavity (33′) may extend from the first back portion (40) to the second back portion (41) through the front portion (42) and the opposite lateral portions (43, 44). Each of the lateral portions (43, 44) and the front portion (42) may include at least one drain opening (35, 35′), with the drain openings preferably but not necessarily on the buccal surface (B) of the arch or mold.

In some embodiments, at least one of the front portion (42) and the pair of lateral portions (43, 44) includes two drain openings (e.g., each lateral portion includes one drain opening, and the front portion includes one drain opening or two spaced apart drain openings; each lateral portion includes two spaced apart drain openings and the front portion includes one drain opening; one lateral portion includes two drain openings and the front portion includes one drain opening, etc, with the drain openings preferably on the buccal surface B of the arch or mold.)

In some embodiments, the drain openings (35, 35′) are uniformly spaced apart from one another.

In some embodiments, each back portion (40, 41) includes either a drain opening or a vent opening (35v).

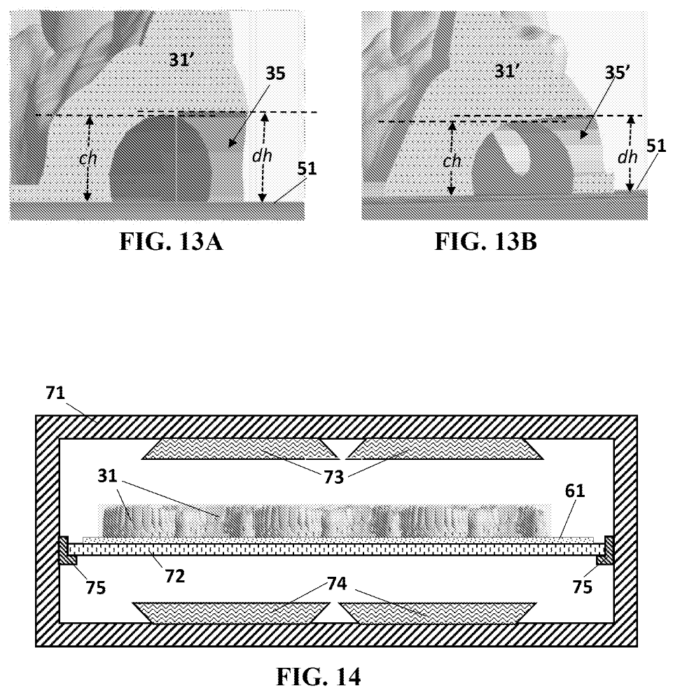

Referring to FIGS. 13A and 13B. a height (dh) of each drain opening (35, 35′) may be greater than a height (ch) of the cavity (33′) in the region of the cavity (33′) adjacent each drain opening (35, 35′). The height (dh) of each drain opening (35, 35′) or at least some of the drain openings (35, 35′) may be: (i) substantially the same through the arch or mold; or (ii) contoured through the arch or mold in a configuration to facilitate the flow of residual resin out of the hollow cavity (33′) during centrifugation on a carrier platform (see, e.g., 50 in FIGS. 7-10) when mounted in any of a plurality (e.g., at least three, four, five, or more) of positions on the carrier platform. In some embodiments, the drain opening (35, 35′) widens or increases in height from the cavity (33′) toward the buccal surface (B) (see, e.g., FIGS. 12A and 12B).

While in a preferred embodiment the molds might be positionable in a near infinite number of orientations, a small number of different orientations on the carrier platform should provide the flexibility to “pack” a large number of molds onto a single carrier platform.

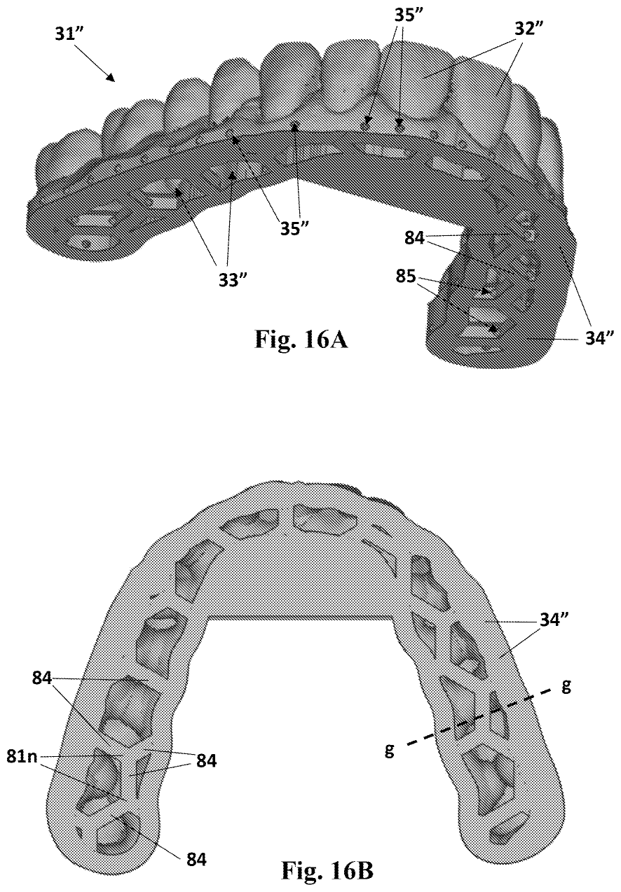

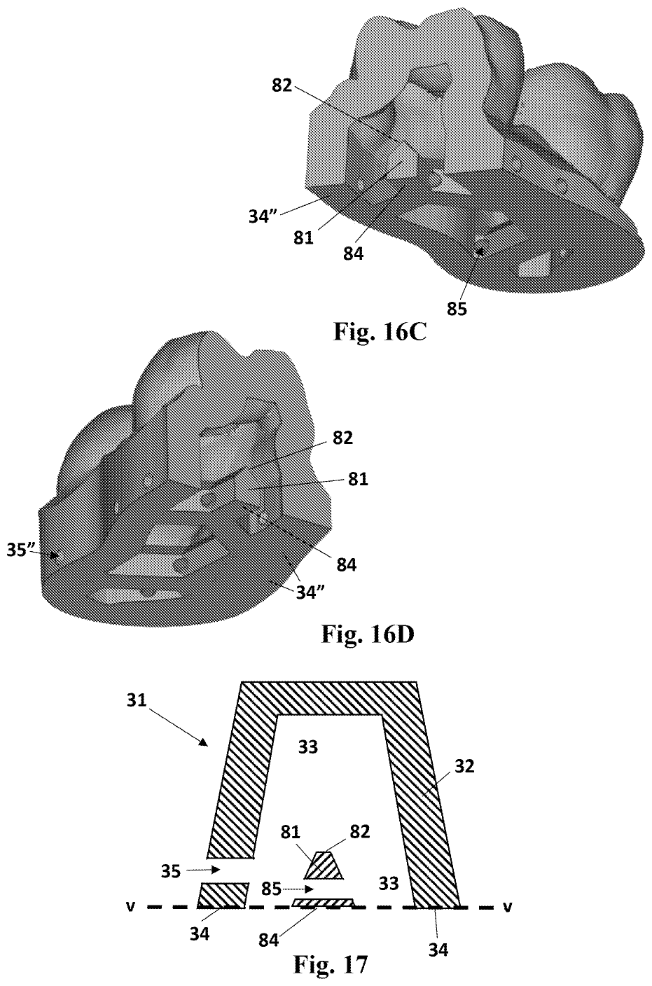

Base grid. In some preferred embodiments, and as illustrated in FIGS. 16A-16D, each said plurality of hollow molds further comprises one or more grids formed in and supporting the hollow cavity 33″. Such grids allow more extensive hollowing of the mold, while retaining dimensional stability of the mold, and resulting accuracy of dental appliances thermoformed thereon.

The grid or grids are typically formed of struts 81, optionally with at least some of the struts interconnected at nodes 81n.

The struts generally have top 82, bottom 84, and side surface portions. In some embodiments, the bottom surface portions 84 are coplanar with the base surface portions 34″, such that all are adhered to the build platform. Numerous different configurations of grids can be used to support the hollow cavity. While in the illustrated embodiments the grid is a single planar (or “two dimensional”) grid, in other embodiments multiple two-dimensional grids can be included inside the hollow cavity in a tiered fashion, or a three-dimensional grid or lattice can be used, with struts extending further upward into the cavity to further support the walls of the mold. In some embodiments, the strut top portions 82 have a configuration, such as a peaked or domed configuration, that promotes drainage of residual resin out of the hollow cavity during centrifugation. In some embodiments, the struts themselves include resin drain openings 85 to further facilitate the drainage of residual resin out of the hollow cavity during centrifugation.

As noted, inclusion of the grid(s) allows more extensive hollowing, while maintaining dimensional stability of, the model. In some embodiments, hollowing is such that at least 30 percent (up to at least 50, 60, or 70 percent or more) of the total volume of the mold is occupied by the hollow cavity). As schematically illustrated in FIG. 17, total volume is defined as the volume defined by a boundary circumscribed by (a) the outer surface of the mold 31, plus a plane (line v-v in FIG. 17) drawn across the bottom surface portion 34 of the mold, with the volume of the cavity not including space occupied by the grid.

Centrifugal separation with solvent vapor. In some embodiments, the centrifugally separating step is carried out in an enclosed chamber containing a volatile organic solvent vapor, optionally but preferably without contacting liquid organic solvent to the hollow molds (e.g., with the solvent in gas form, rather than as a spray or mist of liquid droplets). In preferred embodiments, the vapor is present in an amount sufficient to reduce the viscosity of the residual resin.

Suitable solvents for volatilization in the methods and apparatus include, but are not limited to, alcohol, ester, dibasic ester, ketone, acid, aromatic, hydrocarbon, ether, dipolar aprotic, halogenated, and base organic solvents, and combinations thereof. In some embodiments, the solvent comprises a hydrofluorocarbon, a hydrofluoroether, or a combination thereof. In some embodiments, the solvent is or includes an azeotropic mixture comprised of at least a first organic solvent and a second organic solvent. Solvents can be heated to aid in their volatilization as necessary, and the inner chamber of the separator can be heated to maintain the solvent in a volatile state as necessary. Particular examples of solvents include, but are not limited to, methanol, acetone, isopropanol, and non-flammable organic solvents (e.g., trichlorethylene, methylene chloride, NOVEC™ solvent, VERTREL™ solvent, etc.)

Thus, in some embodiments, a method of cleaning residual resin from an additively manufactured hollow molds includes:
(a) enclosing the additively manufactured hollow molds in an inner chamber of a centrifugal separator, each additively manufactured hollow mold including a light polymerized resin with a surface coating of viscous, unpolymerized, residual resin;
(b) flooding the chamber with a volatile organic solvent vapor without contacting liquid organic solvent to each hollow mold, the vapor present in an amount sufficient to reduce the viscosity of the residual resin; and
(c) spinning the additively manufactured hollow molds in the chamber to centrifugally separate at least a first portion of the residual resin from the object.

In some embodiments, the method further includes generating the solvent vapor from liquid solvent inside said inner chamber.

In some embodiments, the method further includes generating the solvent vapor from liquid solvent outside the inner chamber, and then passing the solvent vapor into the inner chamber.

In some embodiments, the generating step is carried out by heating the liquid solvent, bubbling gas (e.g., air) through the liquid solvent, or a combination thereof.

In some embodiments, the flooding and spinning steps are carried out at ambient pressure and temperature.

In some embodiments, the solvent is selected from the group consisting of methanol, acetone, and isopropanol.

In some embodiments, the solvent is a non-flammable organic solvent (e.g., trichlorethylene, methylene chloride, NOVEC™ solvent, VERTREL™ solvent, etc.) In other embodiments, such as where the solvent is a flammable organic solvent, the inner chamber of the separator may be flooded with an inert gas such as nitrogen to reduce the risk of combustion.

In some embodiments, the spinning step is followed by the steps of: condensing the solvent vapor to produce recovered liquid solvent, collecting the recovered liquid solvent, and optionally (but in some embodiments preferably) re-volatilizing the recovered liquid solvent and then repeating steps (a) to (c) with the re-volatized recovered liquid solvent and a subsequent additively manufactured object.

3. Post-Spin-Clean Cure of Objects while on Release Sheet.

After residual resin is centrifugally separated from the printed objects, the objects can be further cured by exposure to light, particularly ultraviolet light. An example of a post-production curing chamber for carrying out this exposure is shown in FIG. 14, where the apparatus includes a housing (71) having an access door (not shown); a light transmissive tray (72) within said housing, the tray configured to receive a light-transmissive release sheet having a plurality of additively manufactured objects thereon; (c) an ultraviolet light source (73) connected to the housing and positioned to project light down toward said light transmissive tray (and thereby further curing a thin layer of resin on the top surface of cleaned objects); and (d) an ultraviolet light source (74) connected to the housing and positioned to project light up through said light transmissive tray (and thereby further curing a thin layer of resin on the bottom surface, and interior surfaces of a hollow cavity of each object). Objects 31 are conveniently retained on the release sheet (61) which is placed on the tray, and the release sheet is made of a light-transmissive material so light can pass through it to the bottom surfaces of the objects.

If desired, an inert gas source (e.g., a nitrogen source) can be connected to said housing.

The light transmissive tray can be made from any suitable material, including but not limited to tempered glass, sapphire, or a combination thereof. The light transmissive tray is preferably a solid, continuous, sheet of material, rather than a perforated tray, grill, or grating, so that light transmission therethrough is substantially uniform. The housing can be provided with mounts or rails (75) on the interior thereof, so that the tray can slide into the chamber, or be lifted and dropped into the chamber, in an appropriate alignment with respect to the light sources (73, 74).

### 4. Process Overview.

An overview of the process described herein is given in FIG. 15. In some embodiments, the process comprises the steps of:
(a) additively manufacturing (102) a plurality of hollow molds as described above from a polymerizable resin,
(b) centrifugally separating (104) residual resin from both the external surface portion and the bottom portion (including the hollow cavity) of each of the plurality of molds (optionally with the supply of organic solvent vapor into the separator (105) as discussed above; and/or optionally including the step of recapturing centrifugally separated resin (106) for use in making additional hollow molds by the processes described herein);
(c) further curing (for example, (108)), concurrently or sequentially, the external surface portion and the bottom portion of each of the plurality of molds with ultraviolet light; then
(d) thermoforming (110) a thermoplastic polymer sheet on each hollow mold top portion to produce the plurality of polymer dental appliances; and then
(e) separating each of the plurality of polymer dental appliances from each corresponding hollow mold.

As noted previously, in preferred embodiments the additive manufacturing step (102) is preceded by the step of applying a release sheet (101) to the build platform of the additive manufacturing apparatus.

In some preferred embodiments, the further curing of the plurality of molds is carried out concurrently—for example, by retaining the plurality of molds on a release sheet that is inserted into a post-printing, and post-centrifugation, light curing chamber, as discussed further herein in connection with FIG. 14). More particularly, in the embodiment of the method shown in FIG. 15, the further curing step (c) is carried out by: (c₁) separating (107) the release sheet from the build platform with the hollow molds retained on the release sheet; and then (c₂) further curing (108) the bottom portions (including the hollow cavities) by illuminating the bottom portions with ultraviolet light through the release sheet (e.g., with an apparatus of FIG. 14); and then (c₃) separating each hollow mold from the release sheet (109).

Examples of dental appliances that can be formed by the methods described herein include, but are not limited to, aligners, orthodontic retainers, orthodontic splints, dental night guards, dental bleaching (or whitening) trays, and combination thereof.

In some embodiments of the methods, the plurality of polymer dental appliances comprises at least one progressive set of dental appliances (e.g., a progressive set of dental aligners) for a specific patient.

In some cases, the thermoplastic polymer sheet from which the dental appliance is thermoformed is comprised of a clear polymer sheet, although for other embodiments translucent, tinted, and/or opaque polymer sheets can be used.

An advantage of some embodiments of the processes described herein is that sufficient residual resin is removed from the aligners to provide good accuracy of thermoformed dental appliances thereon, while at the same time leaving a sufficient thin film for further curing to mask aliasing or other artifacts of the additive manufacturing process, resulting in a smoother finish on the dental appliance. While spraying of liquid solvent onto additively manufactured objects during centrifugal separation has been suggested, such liquid droplets may not provide this balance of potentially competing goals.

A still further advantage of some embodiments of the processes described herein is that, without the inclusion of solvent vapor during the centrifugal separation step, a thin layer of residual resin on the release sheet is solidified during the post-centrifugation cure. When the objects are then separated from the release sheet, this thin layer is also separated, typically as small flakes of hardened resin. These small flakes present at minimum a cleaning and disposal problem, particularly in a manufacturing setting where the process is carried out on a repeated basis.

The foregoing is illustrative of the present invention, and is not to be construed as limiting thereof. The invention is defined by the following claims, with equivalents of the claims to be included therein.

We claim:

1. A method of making a plurality of polymer dental appliances, comprising the steps of:
(a) additively manufacturing a plurality of hollow molds from a polymerizable resin, each said mold having an external surface portion configured in the shape of a dental arch and a bottom portion having a hollow cavity therein, and with said additively manufacturing step carried out with said plurality of hollow molds formed on a build platform;
(b) centrifugally separating residual resin from both said external surface portion and said bottom portion (including said hollow cavity) of each said plurality of molds;
(c) further curing, concurrently or sequentially, said external surface portion and said bottom portion of each said plurality of molds with ultraviolet light; then
(d) thermoforming a thermoplastic polymer sheet on each said hollow mold external surface portion to produce said plurality of polymer dental appliances; and
(e) separating said plurality of polymer dental appliances from said plurality of hollow molds.

2. The method of claim 1, wherein said centrifugally separating step is carried out with said plurality of hollow molds retained on said build platform.

3. The method of claim 2, wherein each said plurality of hollow molds is oriented vertically on said build platform.

4. The method of claim 2, wherein each said plurality of hollow molds is oriented horizontally on said build platform, with said bottom portion on said build platform.

5. The method of claim 4, wherein each said plurality of hollow molds has a plurality of residual resin drain openings formed therein, each drain opening communicating between or extending between said hollow cavity and said external surface portion.

6. The method of claim 5, wherein each said plurality of hollow molds further comprises a grid (e.g., the grid formed from struts, optionally with at least some of the struts interconnected at nodes), the grid formed in and supporting said hollow cavity.

7. The method of claim 6, wherein said grid is on said build platform.

8. The method of claim 6 or 7, wherein at least 30 percent of the total volume of said hollow mold is occupied by said hollow cavity.

9. The method of any preceding claim, said build platform including a release sheet adhered thereto, with said plurality of hollow molds adhered to said release sheet.

10. The method of claim 9, wherein said further curing step (c) is carried out by:
(c₁) separating said release sheet from said build platform with said hollow molds retained on said release sheet; and then
(c₂) further curing said bottom portions (including said hollow cavities) by illuminating said bottom portions with ultraviolet light through said release sheet; and then
(c₃) separating each said hollow mold from said release sheet.

11. The method of claim 10, wherein said further curing of said plurality of hollow molds is carried out concurrently.

12. The method of claim 11, wherein said further curing of said external surface portion and said bottom portion of each said plurality of molds is carried out concurrently.

13. The method of any preceding claim, wherein said thermoplastic polymer sheet comprises a clear polymer sheet.

14. The method of any preceding claim, wherein said dental appliances comprise orthodontic aligners, orthodontic retainers, orthodontic splints, dental night guards, dental bleaching (or whitening) trays, or a combination thereof.

15. The method of any preceding claim, wherein said plurality of polymer dental appliances comprises at least one progressive set of dental appliances (e.g., a progressive set of dental aligners) for a specific patient.

16. The method of any preceding claim, wherein said centrifugally separating step is carried out in an enclosed chamber containing a volatile organic solvent vapor, without contacting liquid organic solvent to said hollow molds, the vapor present in an amount sufficient to reduce the viscosity of said residual resin.

17. The method of any preceding claim, wherein:
at least one or each said arch or mold has a first and second opposing back portions, a front portion, and a pair of opposite lateral portions therebetween;
said cavity extends from said first back portion to said second back portion through said front portion and said opposite lateral portions;
at least one of or each of said lateral portions and said front portion includes at least one drain opening (with the drain openings preferably on the buccal surface B of said arch); and
said centrifugally separating step (b) comprises flowing said residual resin through said cavity and said drain openings.

18. The method of claim 17, wherein at least one of said front portion, and said pair of opposite lateral portions includes two drain openings (e.g., each lateral portion includes one drain opening, and the front portion includes two spaced apart drain openings; each lateral portion includes two spaced apart drain openings and the front portion includes one drain opening; etc, with the drain openings preferably on the buccal surface B of said arch.)

19. The method of claim 17 or 18, wherein said drain openings have an average diameter of from 0.6 to 1.3 millimeters (e.g., 1 millimeter) and are spaced apart from one another an average of from 2 to 8 millimeters (e.g., 4 millimeters).

20. The method of claims 17 to 19, wherein each said back portion includes either a drain opening or a vent opening.

21. The method of claims 17 to 20, wherein the height of each drain opening is greater than the height of said cavity in the region of said cavity adjacent each said drain opening.

22. The method of claims 17 to 21, wherein the height of said cavity is:
(i) substantially the same throughout said arch, or
(ii) contoured through said arch in a configuration to facilitate the flow of residual resin out of said hollow cavity during centrifugation on a carrier platform when mounted in any of a plurality (e.g., at least three, four, five or more) of positions on said carrier platform.

23. A hollow mold produced by additive manufacturing from a polymerizable resin, said mold having an external surface portion configured in the shape of a dental arch and a bottom portion having a hollow cavity therein, said mold having a plurality of residual resin drain openings formed therein, each drain opening communicating between or extending between said hollow cavity and said external surface portion.

24. The mold of claim 23, said external surface portion having an upper portion and a side portion, and with said bottom portion having a base surface portion, with said residual resin drain openings formed in said side portion.

25. The mold of claim 24, wherein said base surface portion is planar.

26. The mold of claim 25, further comprising a grid formed from struts (optionally with at least some of the struts interconnected at nodes), the grid formed in and supporting said hollow cavity.

27. The mold of claim 26, wherein said struts of said grid are coplanar with said base surface portion.

28. The mold of claim 27, wherein said struts have top, bottom, and side surface portions, wherein said bottom surface portions are coplanar with said base surface portion, and wherein:
said top surface portions are configured (e.g., peaked or domed) to promote drainage of residual resin; and/or
said struts include resin drain openings (e.g., channels extending through said side surface portions) formed therein.

29. The mold of claims 26 to 28, wherein at least 30 percent of the total volume of said hollow mold is occupied by said hollow cavity.

30. The mold of claims 24 to 29, wherein said drain openings are either closed from or open to said base surface portion.

31. The mold of claims 25 to 30, wherein:
said arch has a first and second opposing back portions, a front portion, and a pair of opposite lateral portions therebetween;
said cavity extends from said first back portion to said second back portion through said front portion and said opposite lateral portions; and
each of said lateral portions and said front portion includes at least one drain opening (with the drain openings preferably on the buccal surface B of said arch).

32. The mold of claim 31, wherein at least one of said front portion, and said pair of opposite lateral portions includes two drain openings (e.g., each lateral portion includes one drain opening, and the front portion includes two spaced apart drain openings; each lateral portion includes two spaced apart drain openings and the front portion includes one drain opening; etc, with the drain openings preferably on the buccal surface B of said arch.)

33. The mold of claims 24 to 32, wherein said drain openings have an average diameter of from 0.6 to 1.3 millimeters (e.g., 1 millimeter) and are spaced apart from one another an average of from 2 to 8 millimeters (e.g., 4 millimeters).

34. The mold of claims 31 to 33, wherein each said back portion includes either a drain opening or a vent opening.

35. The mold of claims 24 to 34, wherein the height of each drain opening is greater than the height of said cavity in the region of said cavity adjacent each said drain opening.

36. The mold of claims 24 to 35, wherein the height of said cavity is:
(i) substantially the same throughout said arch, or
(ii) contoured through said arch in a configuration to facilitate the flow of residual resin out of said hollow cavity during centrifugation on a carrier platform when mounted in any of a plurality (e.g., at least three, four, five or more) of positions on said carrier platform.

37. A post-production curing chamber for additively manufactured objects, comprising:
(a) a housing having an access door;
(b) a light transmissive tray within said housing configured to receive a light-transmissive release sheet having a plurality of additively manufactured objects thereon; and
(c) an ultraviolet light source (e.g., a first ultraviolet light source) connected to said housing and positioned to project light down toward said light transmissive tray; and
(d) an ultraviolet light source (e.g., a second ultraviolet light source) connected to said housing and positioned to project light up through said light transmissive tray.

38. The curing chamber of claim 37, further comprising an inert gas source (e.g., a nitrogen source) connected to said housing.

39. The curing chamber of claim 37 or 38, wherein said light transmissive tray comprises tempered glass, sapphire, or a combination thereof.

40. The curing chamber of claims 37 to 39, wherein said light transmissive tray is removably or slidably received on mounts or rails in said housing.
